(19) United States
(12) Patent Application Publication
(10) Pub. No.: US 2014/0004959 A1
(43) Pub. Date: Jan. 2, 2014

(54) SHARING PHOTOS OF A GAME BOARD WITHIN AN ONLINE GAME

(71) Applicants: Brian Kahrs, San Francisco, CA (US); Robby Abaya, New York, NY (US); Jon Martin, San Francisco, CA (US)

(72) Inventors: Brian Kahrs, San Francisco, CA (US); Robby Abaya, New York, NY (US); Jon Martin, San Francisco, CA (US)

(73) Assignee: Zynga Inc., San Francisco, CA (US)

(21) Appl. No.: 13/929,169

(22) Filed: Jun. 27, 2013

Related U.S. Application Data
(60) Provisional application No. 61/665,224, filed on Jun. 27, 2012.

(51) Int. Cl. A63F 13/12

(52) U.S. Cl. CPC A63F 13/12
USPC 463/42

(57) ABSTRACT

A computer-implemented method and system are described to capture and share photos of a game board within an online gaming environment. In some example embodiments, the method and system includes a photo system that enables players to capture photos of their game boards, such as their decorated game boards, and share these photos with other players within their social network, within their gaming network, within a shared game, and so on. In some example embodiments, the photo system may facilitate the reception of feedback, and display information associated with the feedback along with the photos. In some example embodiments, the photo system may perform one or more actions associated with captured photos.

### CROSS REFERENCE TO RELATED APPLICATIONS

This application claims priority to U.S. Provisional Patent Application No. 61/665,224, filed on Jun. 27, 2012, entitled SHARING PHOTOS OF A GAME BOARD WITHIN AN ONLINE GAME, which is hereby incorporated by reference in its entirety.

### FIELD

The present disclosure generally relates to sharing photos of a game board within an online game.

### BACKGROUND

Conventional online games incentive players for a variety of things. For example, a game may reward players for achieving certain goals or levels, for winning a game, for bringing other players to the game, for performing tasks within a game, and so on. In some cases, a provider of online games seeks to increase the number of players going to and playing the online games, and provides various incentives associated with the games, in order to realize the increase in players and gaming time.

### BRIEF DESCRIPTION OF THE DRAWINGS

The example embodiments are illustrated by way of example, and not limitation, in the figures of the accompanying drawings, in which like reference numerals indicate the same or similar elements unless otherwise indicated.

FIG. 1 is a block diagram illustrating a suitable online gaming environment for capturing and sharing photos of player game boards, in some example embodiments.

FIG. 2 is a block diagram illustrating components of a photo system, in some example embodiments.

FIGS. 3A-3D illustrate example graphical user interfaces (GUIs) for facilitating the capturing of photos and performing actions associated with photos, in some example embodiments.

FIG. 4 is a flow diagram illustrating an example method for sharing a photo of a player game board, in some example embodiments.

FIG. 5 is a flow diagram illustrating an example method for offering virtual items for purchase contained within a captured photo, in some example embodiments.

FIG. 6 is a flow diagram illustrating an example method for providing incentives to players based on photos of game boards, in some example embodiments.

FIG. 7 is a flow diagram illustrating an example method for automatically capturing a photo of a player game board, in some example embodiments.

FIG. 8 illustrates a social network within a social graph used to capture and share photos within an online gaming environment, in some example embodiments.

FIG. 9 illustrates example data flow between components of the example computing environment of FIG. 1;

FIG. 10 illustrates an example network environment in which various embodiments of the technology may operate; and

FIG. 11 illustrates an example computing system architecture, which may be used to implement one or more of the methodologies described herein.

### DESCRIPTION OF EXAMPLE EMBODIMENTS

### Overview

Example systems and methods for capturing photos of player game boards within an online game and sharing and/or performing other actions associated with the captured photos, are described. In some example embodiments, the systems and methods include a photo system that enables players to capture photos of their game boards, such as decorated game boards, and share these photos with other players within their social network, within their gaming network, within a shared game, and other collaborative or shared online environments.

In some example embodiments, the photo system may facilitate the reception of feedback and/or display information associated with the feedback along with the photos. For example, the photo system may perform one or more actions associated with captured photos.

In some example embodiments, the systems and methods may facilitate the online game to offer virtual items for sale that are contained by and/or displayed by photos of game boards captured by players of an online game. For example, the photo system may tag or otherwise identify virtual items within a captured photo of a game board, and display, along with the displayed photo, an indication that the virtual item is for sale, such as a graphical element that, when selected, enables a player to purchase or otherwise obtain the virtual item.

In some example embodiments, the systems and methods facilitate the online game to incentivize and/or reward players of an online game for capturing photos of their game boards. For example, the photo system may initiate a contest or incentive program that identifies an achievement or goal that is associated with captured photos by a player or a group of players, and reward the player or players who reach the achievement or meet the goal, among other things.

In some example embodiments, the systems and methods facilitate the online game to create a photo album or other photo-based historical record of a player's or players' achievements by automatically capturing photos of a player's game board in response to the player reaching certain achievements, events, stages, levels, winnings, and so on, while playing an online game.

These and other example embodiments are described, by way of example, in further detail below.

### Example System

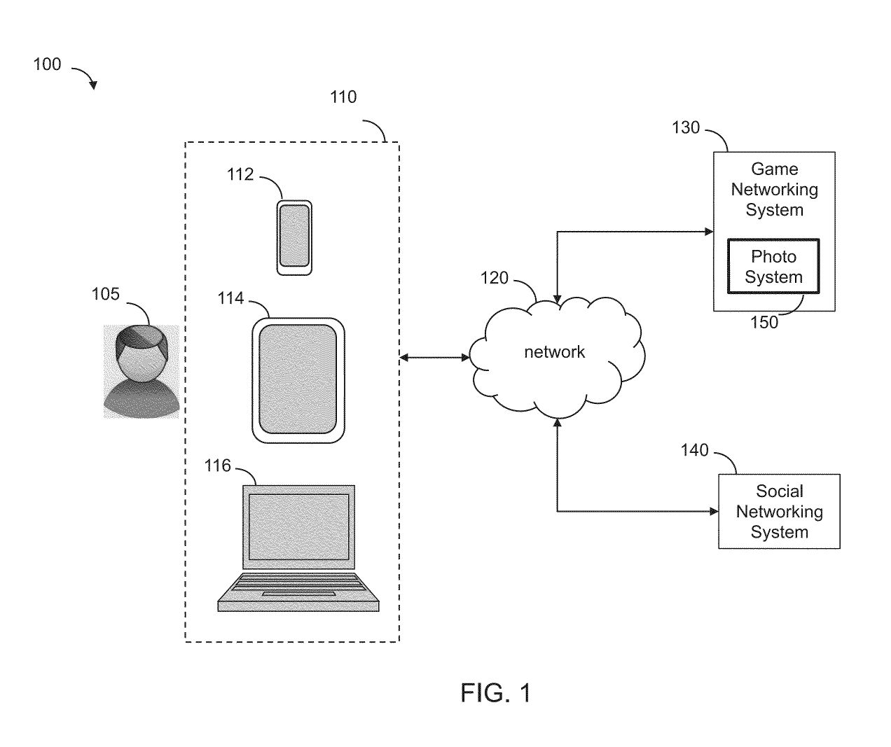

FIG. 1 is a block diagram illustrating a suitable online gaming environment 100 for capturing and sharing photos of player game boards, in some example embodiments.

The online gaming environment 100 may include a user device 110 associated with a player 102 of an online game, a network 120, a social networking system 140, a game networking system 130, and a photo system 150. The example components of the online gaming environment 100 may be connected directly or via the network 120, which may be any suitable network. In various example embodiments, one or more portions of the network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, any other type of network, or a combination of two or more such networks.

Although FIG. 1 illustrates a particular example of the arrangement of the player 105, the user device 110, the social networking system 140, the game networking system 130, the game system 150, and the network 120, this disclosure includes any suitable arrangement or configuration of the player 105, the user device 110, the social networking system 140, the game networking system 130, the photo system 150, and the network 120.

The user device 110 may be any suitable computing device, such as a smart phone 112, a tablet 114, a laptop 116, and/or any mobile device or computing device suitable for playing a virtual game. The user device 110 may access the social networking system 140 or the game networking system 130 directly, via the network 120, or via a third-party system. For example, the user device 110 may access the game networking system 130 via the social networking system 140, or vice versa. It should be noted that the functionality described herein may reside partially or wholly on any one device or be distributed across several devices. For example, the game networking system 130 may partially or wholly provide aspects of the photo system 150, the user device 110 may partially or wholly provide aspects of the photo system 150, and so on. In some example embodiments, a script operating in conjunction with a browser running on the user device 110 may facilitate the capture and sharing of photos, among other things.

Capturing Photos, Sharing Photos, and Performing Actions within an Online Game

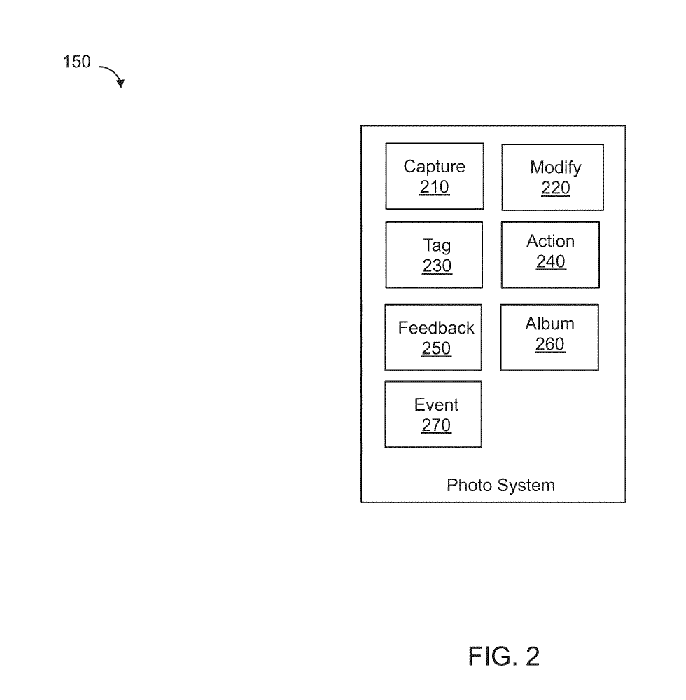

As described herein, in some example embodiments, the photo system 150 enables players of an online game to capture photos of game boards within an online game, and share the photos and/or perform other actions associated with the photos, among other things. FIG. 2 is a block diagram illustrating components of a photo system 150, in some example embodiments.

In some example embodiments, the photo system 150 includes a capture module 210, a modify module 220, a tag module 230, an action module 240, a feedback module 250, an album module 260, and/or an event module 270. The modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system (smart phones, tablet computers, or the like, a client computer system, or a server computer system) or one or more hardware modules of a computer system (e.g., a processor or a group of processors) may be configured by software (e.g., an application or application portion) as a hardware module that operates to perform certain operations as described herein. One or more of the modules shown by way of example in FIG. 2 may be hardware modules.

In some example embodiments, a hardware module may be implemented electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) and/or programmed to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

Referring back to FIG. 2, in some example embodiments, the capture module 210 of the photo system 150 is configured and/or programmed to capture or take images, photos or videos within a gaming environment, such as images, photos, or videos of game boards, partial portions or aspects of game boards, and/or other elements displayed during play or use of an online game. For example, the capture module 210 may capture what is displayed to a player 105 via a screen of a user device 110, such as what is displayed via a browser or software application (e.g., an “app”) providing the online game to the player.

The capture module 210 may facilitate the capturing of photos of player game boards at different points of view, at different zoom levels, in two- or three-dimensions, at partial or different locations of a board, and so on. Also, the capture module 210 may facilitate the capture of short video clips of a changing game board. Thus, in some example embodiments, the capture module 210 enables a player to dynamically select the view, angle, and section of a game board in which to capture as a photo.

In some example embodiments, the modify module 220 of the photo system 220 enables a player to modify a captured photo, such as the display characteristics of the captured photo. For example, the modify module 220 may be configured and/or programmed to apply one or more display filters (e.g., a black and white filter, a sepia filter, and so on) to a captured photo, to add graphical elements to a captured photo, to annotate a captured photo, and so on.

In some example embodiments, the tag module 230 of the photo system 150 identifies and/or tags items displayed by or contained within a captured photo. For example, the tag module 230 may be configured and/or programmed to identify virtual items within captured photos using various identification techniques, such as image search techniques, content-based image retrieval (CBIR) systems, “query by example” techniques, filtering techniques (e.g., using color, texture, shape, and so on match images), semantic retrieval techniques, and other known identification and/or tagging techniques.

The tag module 230 may tag various types of items within a photo, such as virtual items, background items, items won or purchased by a player, decorations, and so on. For example, the tag module 230 may identify and tag virtual items to be offered for sale within an online game and/or virtual items that are part of an incentive program or contest initiated by an online game, among other things.

In some example embodiments, the action module 240 of the photo system 150 performs actions associated with captured photos. For example, the action module 240 may be configured and/or programmed to perform a variety of different actions associated with a captured photo, including actions associated with virtual items displayed by a photo. Example actions may include offering a virtual item within a photo for sale, updating an album with a captured photo, providing rewards or incentives to players taking photos, and so on.

In some example embodiments, the feedback module 250 of the photo system 150 displays feedback, such as ratings, comments, annotations, or other feedback, along with captured photos. For example, the feedback module 250 may be configured and/or programmed to a present a graphical user interface to players within an online game through the players may provide certain feedback. The GUI may enable players to rate a photo, like a photo, comment on a photo, further annotate or edit a photo, and so on.

In some example embodiments, the album module 260 of the photo system 150 updates and/or creates an online photo album of photos captured of a player game board. For example, the album module 260 may be configured and/or programmed to update a photo album or other repository with photos captured by a player of his or her game board. In some example embodiments, the album module 260 may create and/or update different types of photo albums, such as albums associated with a player, albums associated with a group of players, albums associated with an online game, albums associated with certain virtual items within photos, and so on. The album module 260 may enable access to the photos within an album to all players, players within a common social network, players currently playing an online game, players associated with an online game, players that have uploaded photos, and so on.

In some example embodiments, the event module 270 initiates an automatic capture of a photo of a player game board in response to an occurrence of an event within an online game. For example, the event module 270 may be configured and/or programmed to detect or determine a certain event has occurred within an online game, and instruct the capture module 210 to take or capture one or more photos of the game board during the event. Example events that may trigger an automatic capture of a photo of a game board include a player reaching a certain level or achievement within a game, a player winning a game or a portion of a game, a player placing certain decorations on his or her game board, a player interacting with a certain other player (e.g., a friend within the player's social network), and so on.

In some example embodiments, the photo system 150 may determine or select the events that may trigger an automatic capture of a photo of a game board. In some example embodiments, the photo system 150 may receive input from a player and configure settings for the player as to the events that may trigger an automatic capture of a photo of a game board.

Of course, one of ordinary skill in the art will realize that the photo system 150 may include other modules not shown in FIG. 2, such as modules that store information associated with game play, user information, photo information, and so on.

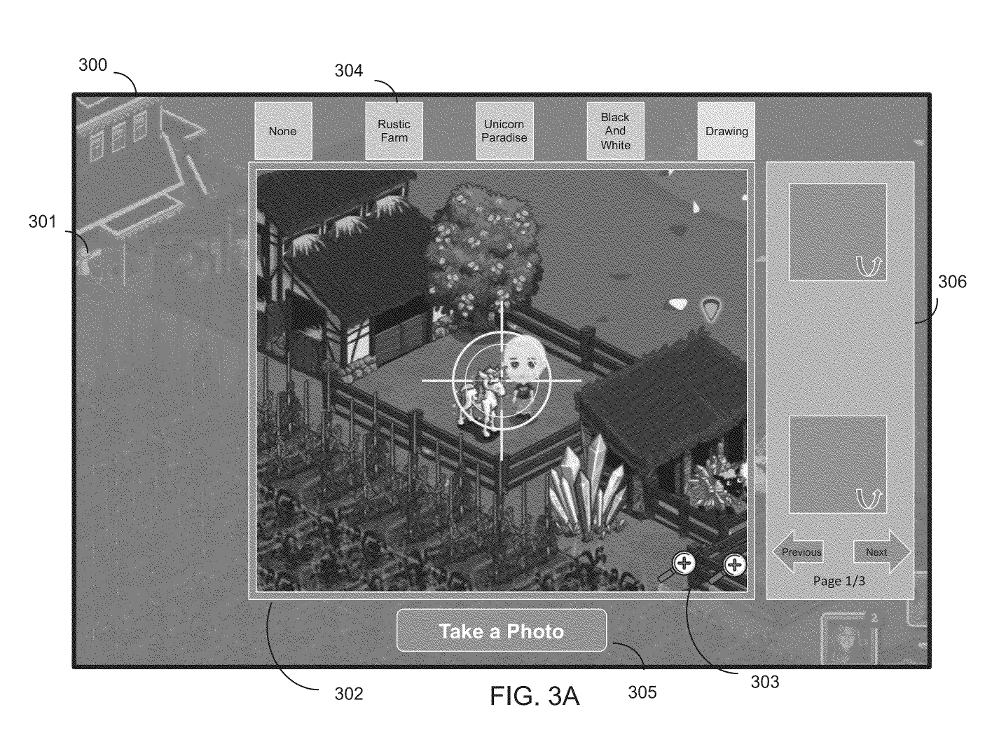

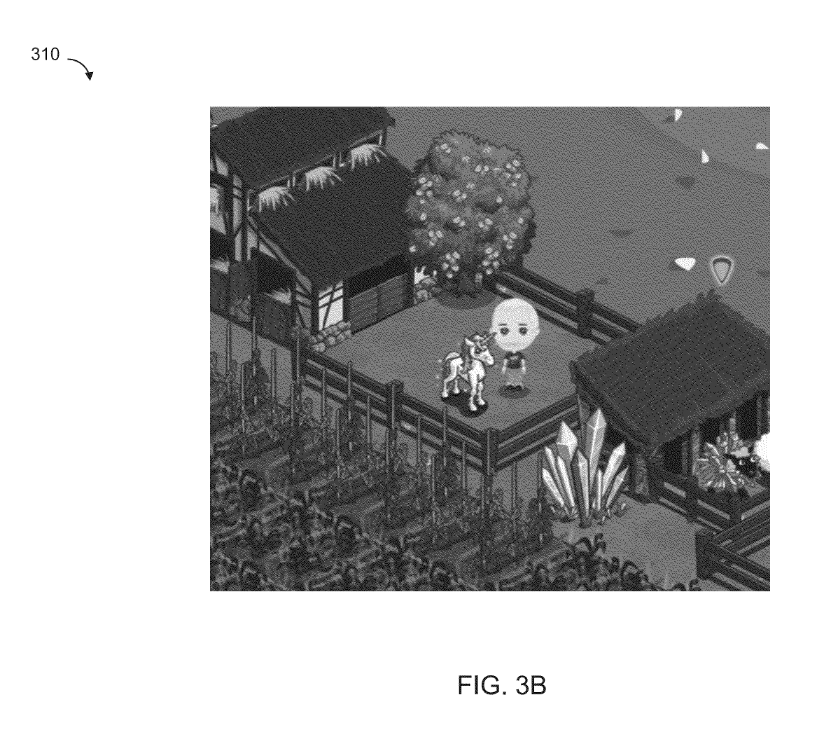

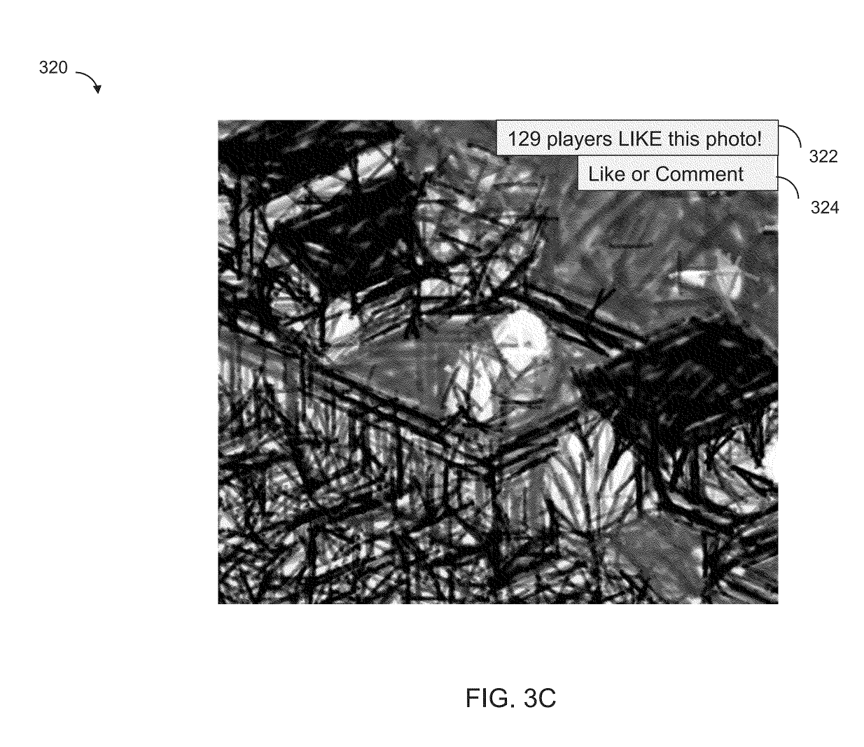

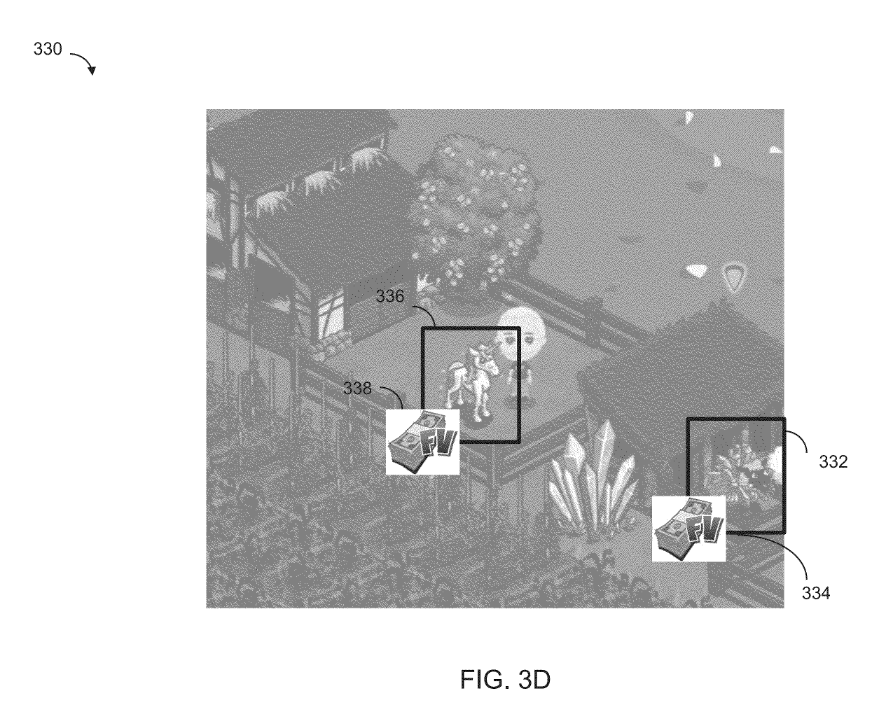

As described herein, in some example embodiments, the photo system 150 enables players of an online game to take photos of their game boards, and perform various actions associated with the photos. FIGS. 3A-3D illustrate example graphical user interfaces (GUIs) for facilitating the capturing of photos and performing actions associated with photos, in some example embodiments.

FIG. 3A depicts a user interface 300 provided by the photo system 150 through which a player may capture a photo of his or her game board. The user interface 300 displays the user's game board 301, a user-selectable capture element 302, a user-selectable zoom element 303, one or more user-selectable filter elements 304, a photo capture element 305, a navigation tool 306, and other displayed graphical element.

In some example embodiments, a player utilizes the capture element 302 to select (e.g., crop) a portion of the game board 301 to be captured in a photo. The player may then use the zoom element 303 to change the view of the game board, or may use other elements (not shown) that adjust the point of view of the game board to be captured. The player may also modify the game board before (or, after) a photo is taken with one or more filters 304, such as filters that recolor the game board in a “sepia tone” or display the farm as a “rustic farm,” among other things. The player may then select the capture element 305 to take a photo, which is shown in FIG. 3B.

FIG. 3B depicts a photo 310 taken of the game board 301 using the user interface 300. FIG. 3C depicts a photo 320 taken of the game board 301 using the user interface 300 with a filter 304 applied to the photo, in this example, the “drawing” filter. Additionally, feedback 324 is displayed along with the photo 320, along with user-selectable graphical elements 322 that facilitate a viewer liking or commenting on a photo, among other things.

FIG. 3D depicts a photo 330 taken of the game board 301 using the user interface 300, along with indications 334, 338 that certain items, such as a goat 332 and a unicorn 336, may be purchased by players viewing the photos. For example, the indication 338 proximate to the unicorn 334 may, upon being selected by a viewer of the photo 330, enable the viewer to purchase a unicorn for his or her own use within an online game, among other things.

Of course, one or ordinary skill in the art will realize that other game boards, decorations, virtual items, photo elements, and so on may be presented by the photo system when enabling players to capture photos of game boards, among other things.

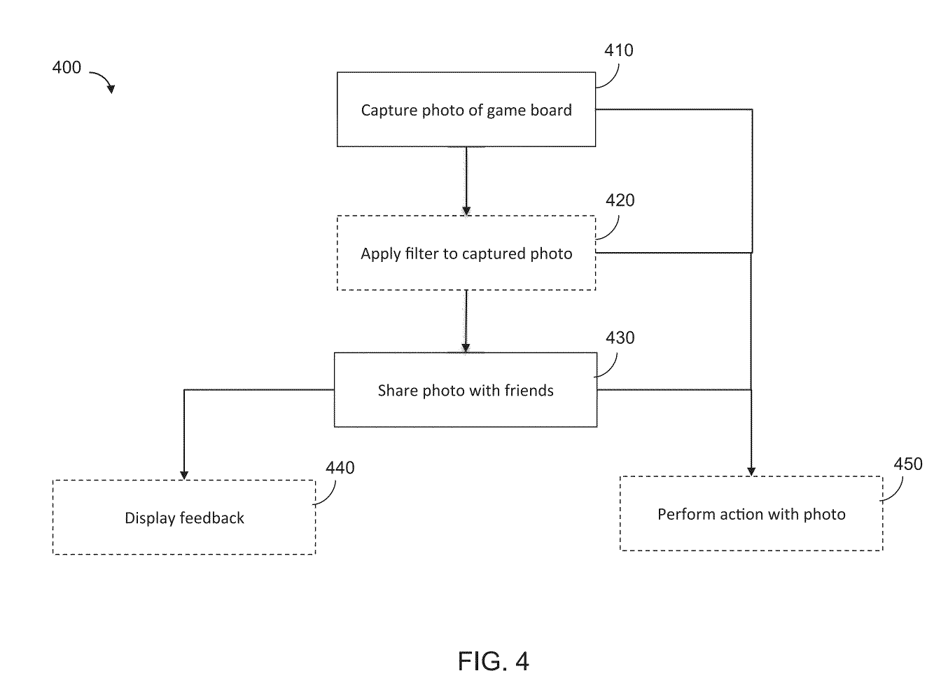

As described herein, in some example embodiments, the photos system 150 enables players to take photos of their game boards and share the photos with other players in their game or social networks, among other things. FIG. 4 is a flow diagram illustrating an example method 400 for sharing a photo of a player game board, in some example embodiments. The method 400 may be performed by the photo system 150 and, accordingly, is described herein merely by way of reference thereto. It will be appreciated that the method 400 may be performed on any suitable hardware.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a geographic location (e.g., within a home environment, an office environment, or a server farm). In other example embodiments, the one or more processors or processor-implemented modules may be distributed across a number of geographic locations.

Returning to FIG. 4, in operation 410, the photo system 150 captures a photo of a game board. For example, the photo system 150, via the capture module 210, captures a selected portion of a game board in response input received from a player associated with the game board.

In operation 420, the photo system 150 optionally applies a filter or otherwise modifies the captured photo. For example, the photo system 150, via the modify module 220, applies a filter, edits, annotates, captions, or otherwise modifies the captured photo in response to input received from the player.

In operation 430, the photo system 150 shares the photo with friends of the player. For example, the photo system 150, via the action module 240, feedback module 250, and/or album module 260, enables other players within an online game and/or social network in common with the player to view the photo. The photo system 150 may update other player's game environments with the captured photos, may create and/or update a photo album with the captured photo, may update the player's or other player's social network timelines with the captured photo, may generate blog or micro-blog entries with the captured photo, and so on.

In operation 440, the photo system 150 may optionally display feedback along with the photo. For example, the photo system 150, via the feedback module 250, may facilitate receiving comments, likes, and other feedback from other players and social network friends of a player, and display that feedback along with the photo when the photo is displayed. Example feedback that may be displayed includes receiving “likes” or other indications of approval, receiving comments, sections of a photo being tagged, and so on.

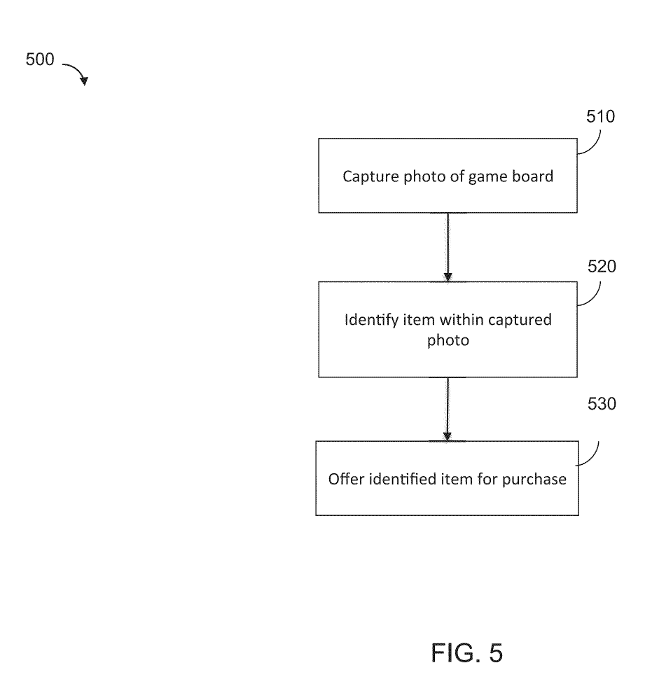

In operation 450, the photo system 150 may optionally perform an action associated with the photo. For example, the photo system 150, via the action module 260, may perform various actions associated with a captured photo. Further details regarding example actions performed by the photo system 150 are described with respect to FIGS. 5 and/or 6. As illustrated in FIG. 4, in some examples, the photo system 150 may perform an action associated with the photo after a photo is captured (step 410), after a filter is applied to a captured photo (step 420), after a photo is shared (step 430), and so on. For example, the photo system 150 may perform an action associated with one or more photos displayed shared with users via a photo album of a player.

FIG. 5 is a flow diagram illustrating an example method 500 for offering virtual items for purchase contained within a captured photo, in some example embodiments. The method 500 may be performed by the photo system 150 and, accordingly, is described herein merely by way of reference thereto. It will be appreciated that the method 500 may be performed on any suitable hardware.

In operation 510, the photo system 150 captures a photo of a game board. In operation 520, the photo system 150 identifies or tags virtual items within or displayed by the captured photo. In operation 530, the photo system 150 offers the identified items for purchase. For example, the photo system 150, via the tag module 230 and/or the action module 260, may identify an item within a captured photo as a decoration generally for sale within an online game, and display, along with the photo, indications that the item is for sale, or may be obtained, by views of the photo. The photo system may offer the item for purchase with real money, with virtual money, with other virtual currency, and so on.

In some example embodiments, the photo system 150 may offer for sale many different virtual items, such as decorations, weapons, buildings, background items, avatars, and so on. In some examples, the photo system 150 may collaborate with a player providing the photo, and reward the player with virtual currency or other credits when viewers of his or her photos make purchase via his or her photos.

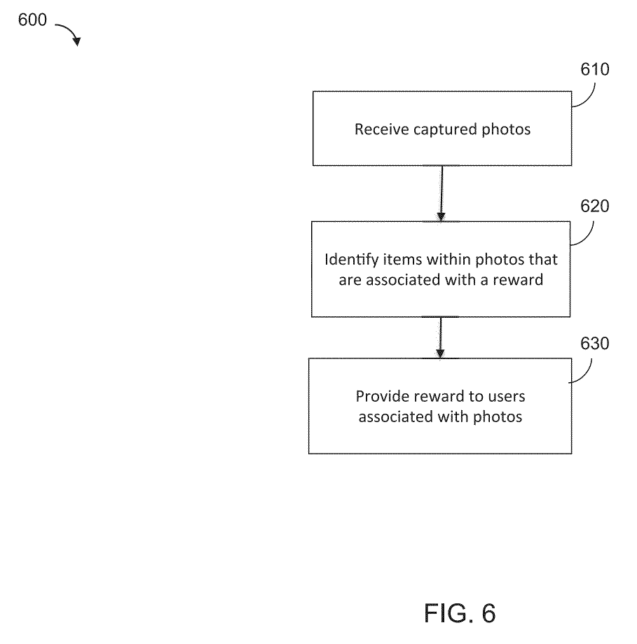

Thus, in some example embodiments, the photo system 150 may provide incentives to players to take photos and share the photos within their online gaming environment, among other benefits. FIG. 6 is a flow diagram illustrating an example method 600 for providing incentives to players based on photos of game boards, in some example embodiments. The method 600 may be performed by the photo system 150 and, accordingly, is described herein merely by way of reference thereto. It will be appreciated that the method 600 may be performed on any suitable hardware.

In operation 610, the photo system 150 receives and/or accesses captured photos, such as photos from a single player, photos from multiple players, and so on. In operation 620, the photo system 150 identified items within the photos associated with a reward. In operation 630, the photo system 150 provides the reward to players associated with the photos. For example, the photo system 150, via the tag module 230 and/or the action module 260, identifies, within shared photos, virtual items associated with a current contest or reward program running in an online game, and provides rewards to players that shared photos that contain the virtual items.

Thus, in some example embodiments, the photo system 150 may provide and/or gift a reward to players that share photos of game boards within a certain time period having a certain decoration, may provide and/or gift a reward to players having the highest rated, most viewed, or most commented on photos, may provide and/or gift a reward to groups of players that collectively fulfill certain achievements, and so on. Therefore, the photo system 150, in some example embodiments, may encourage players to capture photos and share the photos within a game or social network by providing incentives to do so, among other things.

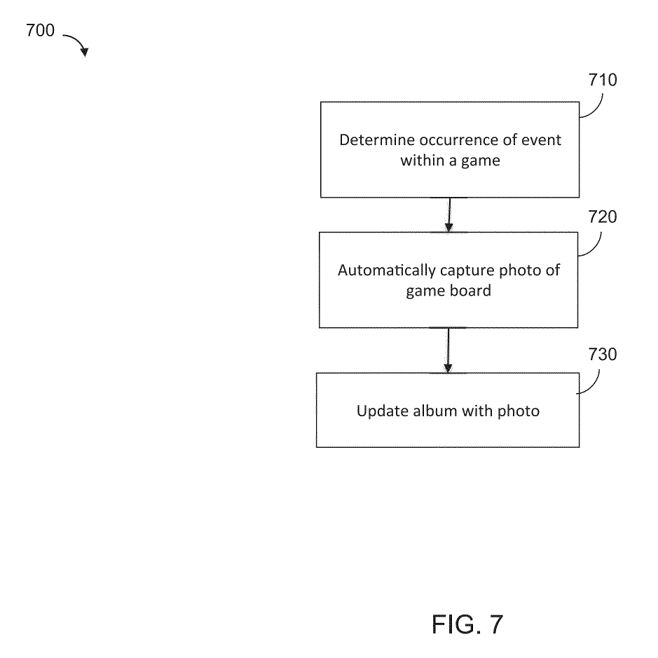

As described herein, the photo system 150, in some example embodiments, may automatically capture photos of game boards when certain events are achieved or otherwise realized by players within an online game. FIG. 7 is a flow diagram illustrating an example method 700 for automatically capturing a photo of a player game board, in some example embodiments. The method 700 may be performed by the photo system 150 and, accordingly, is described herein merely by way of reference thereto. It will be appreciated that the method 700 may be performed on any suitable hardware.

In operation 710, the photo system 150 determines an occurrence of an event within an online game. For example, the photo system 150, via the event module 270, monitors play of an online game and/or receives information associated with an online game, and based on the information, determines a suitable event has occurred within the game. Example suitable events may be a player reaching a certain level or achievement within a game, a player winning a game or a portion of a game, a player placing certain decorations on his or her game board, a player interacting with a certain other player (e.g., a friend within the player's social network), and so on.

In operation 720, the photo system 150 automatically captures a photo of a player game board in response to the determination. For example, the photo system 150, via the event module 270, instructs or causes the capture module 210 to capture a photo of a player game board in response to the occurrence of a certain event within the online game.

In operation 730, the photo system 150 updates or creates a photo album with the captured photo. For example, the photo system 150, via the album module 260, updates an photo album for a player with the captured photo. The photo system 150 may create and/or update various different photo albums to store photos associated with events, such as albums associated with a certain game, a certain instance of a game, a certain player in a game, interactions with other players, achievements within games, winnings within games, and so on.

Thus, in some example embodiments, the photo system 150 may act to automatically create a historical record of a players online gaming experiences, providing a player with photos of various different interactions, achievements, game boards, player ineractions, and so on.

### Example Game Systems, Social Networks, and Social Graphs

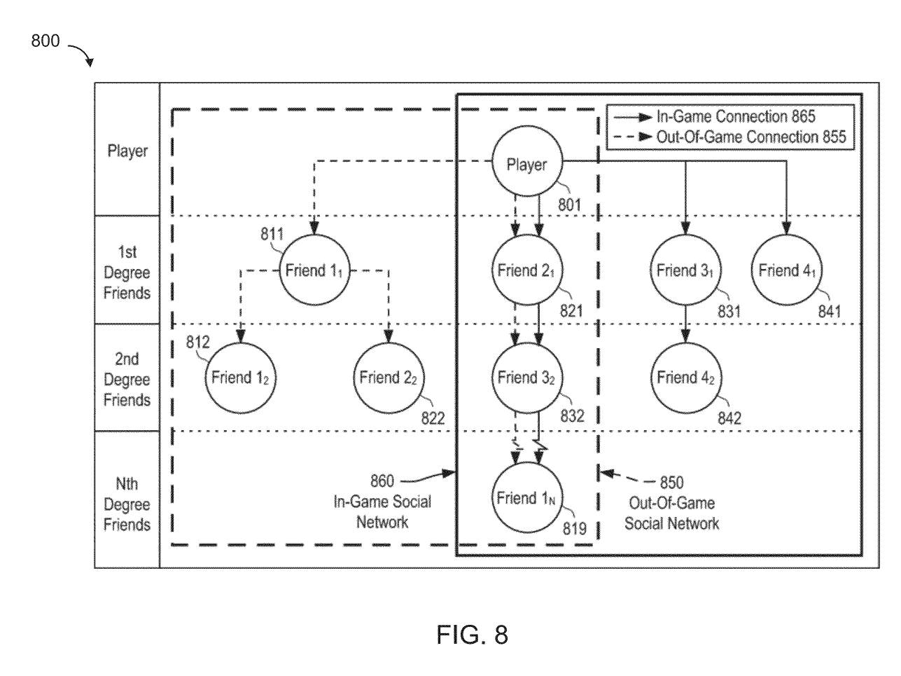

FIG. 8 illustrates a social network within a social graph used to capture and share photos within an online gaming environment, in some example embodiments. In example embodiments, a virtual landscape or environment of a player may be visible to other players of the virtual game.

The social graph 800 is shown by way of example to include an out-of-game social network 850 and an in-game social network 1860. Moreover, the in-game social network 1860 may include one or more players that are friends with the User 801 (e.g., a Friend 831), and may include one or more other users that are not friends with the User 801. The social graph 800 may correspond to the various users associated with the virtual game. In an example embodiment, each user may “build” their own virtual structures using branded virtual objects and/or unbranded virtual objects. In some example embodiments, virtual structures or assets in any one or more of the virtual landscapes of any one or more players in the social graph 800 may be virtual items within captured photos, among other things.

As described above, the example systems described herein may include, communicate, or otherwise interact with a game system. As such, a game system is now described to illustrate further example embodiments. In an online multiuser game, users control player characters (PCs), a game engine controls non-player characters (NPCs); the game engine also manages player character state and tracks states for currently active (e.g., online) users and currently inactive (e.g., offline) users. A game engine, in some embodiments, may include a documentation engine. Alternatively, the documentation engine and game engine may be embodied as separate components operated by the game network system and/or the document provision system.

A player character may have a set of attributes and a set of friends associated with the player character. As used herein, the terms “state” and “attribute” can be used interchangeably to refer to any in-game characteristic of a player character, such as location, assets (e.g., value icons), levels, condition, health, status, inventory, skill set, name, orientation, affiliation, specialty, and so on. The game engine may use a player character state to determine the outcome of a game event, while sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights, and/or benefits or the obtaining of some assets (e.g., health, money (e.g., virtual currency from a value icon), strength, inventory, land, etc.). A game engine may determine the outcome of a game event according to game rules (e.g., “a character with less than 5 health points will be prevented from initiating an attack”), based on a character's state, and also possibly on interactions of other player characters and a random calculation. Moreover, an engagement may include simple tasks (e.g., cross the river, shoot at an opponent, interact with a value icon, or the like), complex tasks (e.g., win a battle, unlock a puzzle, build a factory, rob a liquor store), or other events. Selecting an award based on these events, or capturd photos depicting these events and tasks may enhance the likelihood that a player will enjoy and subsequently rengage with the virtual game.

In a game system according to some aspects of the present disclosure, in determining the outcome of a game event in a game being played by a user (or a group of more than one users), the game engine may take into account the state of the player character (or group of PCs) that is playing, but also the state of one or more PCs of offline/inactive users who are connected to the current user (or PC, or group of PCs) through the game social graph but are not necessarily involved in the game at the time.

For example, a User A with six friends on User A's team (e.g., the friends that are listed, depending on the nature of the game, as being in the user's mob/gang/set/army/business/crew/etc.) may be playing the virtual game and choose to confront a User B who has 20 friends on User B's team. In some embodiments, a user may only have first-degree friends on the user's team. In other embodiments, a user may also have second-degree and higher degree friends on the user's team. To resolve the game event, in some embodiments, the game engine may total up the weapon strength of the seven members of the User A's team and the weapon strength of the 21 members of the User B's team and decide an outcome of the confrontation based on a random variable applied to a probability distribution that favors the side with the greater total. In some embodiments, all of this may be done without any other current active participants other than the User A (e.g., the User A's friends, the User B, and the User B's friends could all be offline or inactive). In some embodiments, the friends in a user's team may see a change in their state as part of the outcome of the game event.

A virtual game may be hosted by the game networking system 130, which can be accessed using any suitable connection 125 with a suitable user device 110. A user may have a game account on the game networking system 130, wherein the game account may contain a variety of information associated with the user (e.g., the user's personal information, financial information, purchase history (e.g., of in-game assets), player character state, game state, or any other user profile data). In some embodiments, a user may play multiple games on the game networking system 130, which may maintain a single game account for the user with respect to the multiple games, or multiple individual game accounts for each game with respect to the user. In some embodiments, the game networking system 130 may assign a unique identifier to a player 105 of a virtual game hosted on the game networking system 130. The game networking system 130 may determine that the player 105 is accessing the virtual game by reading the user's cookies, which may be appended to HTTP requests transmitted by the user device 110, and/or by the player 105 logging onto the virtual game.

In some embodiments, the player 105 accesses a virtual game and controls the game's progress via the user device 110 (e.g., by inputting commands to the game at the user device 110. The user device 110 can display the game interface, receive inputs from the player 105, transmit user inputs or other events to the game engine, and receive instructions from the game engine. The game engine can be executed on any suitable system (such as, for example, the user device 110, the social networking system 140, or the game networking system 130). For example, the user device 110 may download client components of a virtual game, which are executed locally, while a remote game server, such as the game networking system 130, provides backend support for the client components and may be responsible for maintaining application data of the game, processing the inputs from the player 105, updating and/or synchronizing the game state based on the game logic and each input from the player 105, and transmitting instructions to the user device 110. As another example, when the player 105 provides an input to the game through the user device 110 (such as, for example, by typing on the keyboard, clicking the mouse, or interacting with a touch screen of the user device 110), the client components of the game may transmit the user's input to the game networking system 130.

In some embodiments, the player 105 accesses particular game instances of a virtual game. A game instance is a copy of a specific game play area that is created during runtime. In some embodiments, a game instance is a discrete game play area where one or more players 105 can interact in synchronous or asynchronous play. A game instance may be, for example, a level, zone, area, region, location, virtual space, or other suitable play area. A game instance may be populated by one or more in-game objects (e.g., decorations on a game board). Each object may be defined within the game instance by one or more variables, such as, for example, position, height, width, depth, direction, time, duration, speed, color, and other suitable variables.

In some embodiments, a specific game instance may be associated with one or more specific users. A game instance is associated with a specific user when one or more game parameters of the game instance are associated with the specific user. For example, a game instance associated with a first user may be named “First User's Play Area.” This game instance may be populated with the first user's PC and one or more in-game objects associated with the first user.

In some embodiments, a game instance associated with a specific user is only accessible by that specific user. For example, a first user may access a first game instance when playing a virtual game, and this first game instance may be inaccessible to all other users. In other embodiments, a game instance associated with a specific user is accessible by one or more other users, either synchronously or asynchronously with the specific user's game play. For example, a first user may be associated with a first game instance, but the first game instance may be accessed by all first-degree friends in the first user's social network.

In some embodiments, the set of in-game actions available to a specific user is different in a game instance that is associated with this user compared to a game instance that is not associated with this user. The set of in-game actions available to a specific user in a game instance associated with this user may be a subset, superset, or independent of the set of in-game actions available to this user in a game instance that is not associated with him. For example, a first user may be associated with Blackacre Farm in an online farming game and may be able to plant crops on Blackacre Farm. If the first user accesses a game instance associated with another user, such as Whiteacre Farm, the game engine may not allow the first user to plant crops in that game instance. However, other in-game actions may be available to the first user, such as watering or fertilizing crops on Whiteacre Farm. Likewise, a value icons may have restrictions.

In some embodiments, a game engine interfaces with a social graph (e.g., to obtain user profile data from the social graph to, inter alia, configure the virtual sctach cards). Social graphs are models of connections between entities (e.g., individuals, users, contacts, friends, users, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a user or player character in an online multiuser game.

In some embodiments, the social graph is managed by the game networking system 130, which is managed by the game operator. In other embodiments, the social graph is part of a social networking system 140 managed by a third party (e.g., Facebook, Friendster, Myspace, Google+). In yet other embodiments, the player 105 has a social network on both the game networking system 130 and the social networking system 140, wherein the player 105 can have a social network on the game networking system 130 that is a subset, superset, or independent of the user's social network on the social networking system 140. In such combined systems, game network system 130 can maintain social graph information with edge-type attributes that indicate whether a given friend is an “in-game friend,” an “out-of-game friend,” or both. The various embodiments disclosed herein are operable when the social graph is managed by the social networking system 140 the game networking system 130, or both.

Returning to FIG. 8, the User 801 may be associated, connected, or linked to various other users, or “friends,” within the out-of-game social network 850. These associations, connections, or links can track relationships between users within the out-of-game social network 850 and are commonly referred to as online “friends” or “friendships” between users. Each friend or friendship in a particular user's social network within a social graph is commonly referred to as a “node.” For purposes of illustration, the details of out-of-game social network 850 are described in relation to User 801. As used herein, the terms “user” and “player” can be used interchangeably and can refer to any user in an online multiuser game system or social networking system. As used herein, the term “friend” can mean any node within a user's social network.

As shown in FIG. 8, User 801 has direct connections with several friends. When the User 801 has a direct connection with another individual, that connection is referred to as a first-degree friend. In out-of-game social network 850, the User 801 has two first-degree friends. That is, the User 801 is directly connected to Friend 1₁ 811 and Friend 2₁ 821. In social graph 800, it is possible for individuals to be connected to other individuals through their first-degree friends (e.g., friends of friends). As described above, the number of edges in a minimum path that connects a user to another user is considered the degree of separation. For example, FIG. 8 shows that User 801 has three second-degree friends to which User 801 is connected via User 801's connection to User 801's first-degree friends. Second-degree Friend 1₂ 812 and Friend 2₂ 822 are connected to User 801 via User 801's first-degree Friend 1₁ 811. The limit on the depth of friend connections, or the number of degrees of separation for associations, that User 801 is allowed is typically dictated by the restrictions and policies implemented by the social networking system 140.

In various embodiments, User 801 can have Nth-degree friends connected to him through a chain of intermediary degree friends as indicated in FIG. 8. For example, Nth-degree Friend 1_{N} 819 is connected to User 801 within in-game social network 860 via second-degree Friend 3₂ 832 and one or more other higher-degree friends.

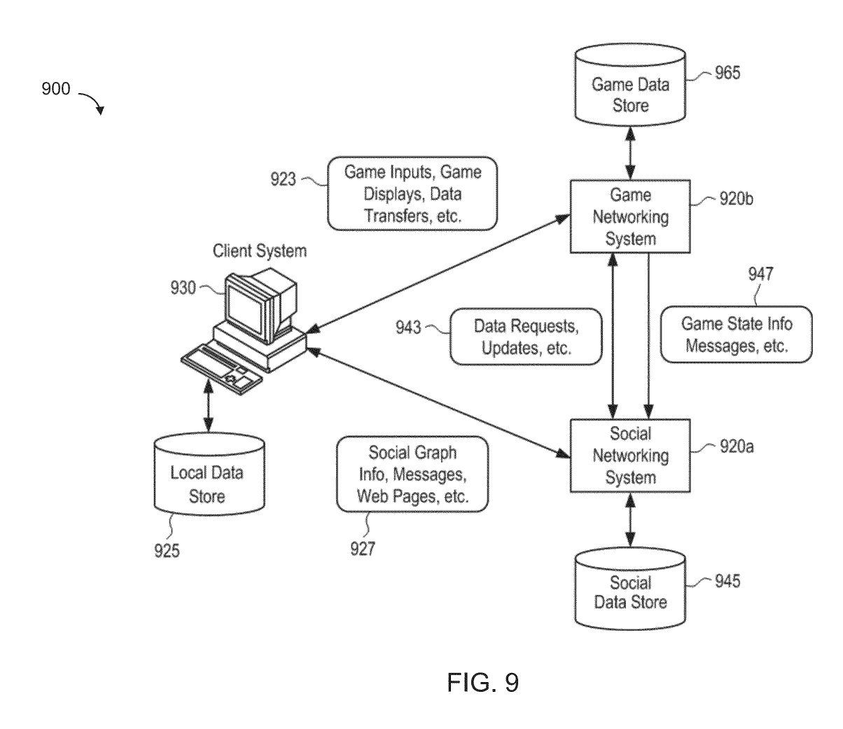

In some embodiments, a user (or player/player character) has a social graph within an online multiuser game that is maintained by the game engine and another social graph maintained by a separate social networking system. FIG. 9 depicts an example of in-game social network 860 and out-of-game social network 850. In this example, User 801 has out-of-game connections 855 to a plurality of friends, forming out-of-game social network 850. Here, Friend 1₁ 811 and Friend 2₁ 821 are first-degree friends with User 801 in User 801's out-of-game social network 850. User 801 also has in-game connections 865 to a plurality of users, forming in-game social network 860. Here, Friend 2₁ 821, Friend 17₁ 831, and Friend 4₁ 841 are first-degree friends with User 801 in User 801's in-game social network 1860. In some embodiments, a game engine can access in-game social network 860, out-of-game social network 850, or both.

In some embodiments, the connections in a user's in-game social network are formed both explicitly (e.g., when users “friend” each other) and implicitly (e.g., when the system observes user behaviors and “friends” users to each other). Unless otherwise indicated, reference to a friend connection between two or more users can be interpreted to cover both explicit and implicit connections, using one or more social graphs and other factors to infer friend connections. The friend connections can be unidirectional or bidirectional. It is also not a limitation of this description that two users who are deemed “friends” for the purposes of this disclosure are not friends in real life (e.g., in disintermediated interactions or the like), but that could be the case.

FIG. 9 illustrates an example data flow between example components of an example system 900. One or more of the components of the example system 900 may correspond to one or more of the components of the example computing environment 100. In some embodiments, system 900 includes a client system 930, a social networking system 920a, and a game networking system 920b. The components of system 900 can be connected to each other in any suitable configuration, using any suitable type of connection. The components may be connected directly or over any suitable network. The client system 930, the social networking system 920a, and the game networking system 920b may have one or more corresponding data stores, such as the local data store 195, the social data store 945, and the game data store 965, respectively.

The client system 930 may receive and transmit data 923 to and from the game networking system 920b. This data can include, for example, a web page, a message, a game input, a game display, a HTTP packet, a data request, transaction information, and other suitable data. At some other time, or at the same time, the game networking system 920b may communicate data 943, 947 (e.g., game state information, game system account information, page info, messages, data requests, updates, etc.) with other networking systems, such as the social networking system 920a (e.g., Facebook, Myspace, etc.). The client system 930 can also receive and transmit data 927 to and from the social networking system 920a. This data can include, for example, web pages, messages, social graph information, social network displays, HTTP packets, data requests, transaction information, updates, and other suitable data.

Communication between the client system 930, the social networking system 920a, and the game networking system 920b can occur over any appropriate electronic communication medium or network using any suitable communication protocol. For example, the client system 930, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a user accesses a virtual game on the game networking system 920b, the BLOB containing the game state for the instance corresponding to the user may be transmitted to the client system 930 for use by a client-side executed object to process. In some embodiments, the client-side executable is a FLASH-based game, which can de-serialize the game state data in the BLOB. As a user plays the game, the game logic implemented at the client system 930 maintains and modifies the various game state parameters locally. The client-side game logic may also batch game events, such as mouse clicks, and transmit these events to the game networking system 920b. Game networking system 920b may itself operate by retrieving a copy of the BLOB from a database or an intermediate memory cache (memcache) layer. The game networking system 920b can also de-serialize the BLOB to resolve the game state parameters and execute its own game logic based on the events in the batch file of events transmitted by the client to synchronize the game state on the server side. The game networking system 920b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a user selects one or more actions to perform. The web pages may be displayed in a browser client executed on the client system 930. For example, a client application downloaded to the client system 930 may operate to serve a set of web pages to a user. As another example, a virtual game may be an animated or rendered game executable as a stand-alone application or within the context of a webpage or other structured document. In some embodiments, the virtual game is implemented using Adobe Flash-based technologies. As an example, a game may be fully or partially implemented as a SWF object that is embedded in a web page and executable by a Flash media user plug-in. In some embodiments, one or more described web pages are associated with or accessed by the social networking system 920a. This disclosure contemplates using any suitable application for the retrieval and rendering of structured documents hosted by any suitable network-addressable resource or website.

Application event data of a game is any data relevant to the game (e.g., user inputs or interations). In some embodiments, each application datum may have a name and a value, and the value of the application datum may change (e.g., be updated) at any time. When an update to an application datum occurs at the client system 930, either caused by an action of a game user or by the game logic itself, the client system 930 may need to inform the game networking system 920b of the update. For example, if the game is a farming game with a harvest mechanic (such as FarmVille by Zynga), an event can correspond to a user clicking on a parcel of land to harvest a crop. In such an instance, the application event data may identify an event or action (e.g., harvest, achievement of a level, or the like) and an object in the game to which the event or action applies.

In some embodiments, one or more objects of a game are represented as an Adobe Flash object. Flash may manipulate vector and raster graphics, and supports bidirectional streaming of audio and video. “Flash” may mean the authoring environment, the user, or the application files. In some embodiments, the client system 930 may include a Flash client. The Flash client may be configured to receive and run a Flash application or game object code from any suitable networking system (such as, for example, the social networking system 920a or the game networking system 920b). In some embodiments, the Flash client is run in a browser client executed on the client system 930. A user can interact with Flash objects using the client system 930 and the Flash client. The Flash objects can represent a variety of in-game objects. Thus, the user may perform various in-game actions on various in-game objects by making various changes and updates to the associated Flash objects.

In some embodiments, in-game actions are initiated by clicking or similarly interacting with a Flash object that represents a particular in-game object. For example, a user can interact with a Flash object to use, move, rotate, delete, scratch, attack, shoot, redeem virtual currency from a value object, or harvest an in-game object. This disclosure contemplates performing any suitable in-game action by interacting with any suitable Flash object. In some embodiments, when the user makes a change to a Flash object representing an in-game object, the client-executed game logic may update one or more game state parameters associated with the in-game object. To ensure synchronization between the Flash object shown to the user at the client system 930, the Flash client may send the events that caused the game state changes to the in-game object to the game networking system 920b. However, to expedite the processing and, hence, the speed of the overall gaming experience, the Flash client may collect a batch of some number of events or updates into a batch file. The number of events or updates may be determined by the Flash client dynamically or determined by the game networking system 920b based on server loads or other factors. For example, client system 930 may send a batch file to the game networking system 920b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to user data or metadata, changes to user social connections or contacts, user inputs to the game, and events generated by the game logic. The user profile data may include application event data. In some embodiments, each application datum has a name and a value. The value of an application datum may change at any time in response to the game play of a user or in response to the game engine (e.g., based on the game logic). In some embodiments, an application data update occurs when the value of a specific application datum is changed.

In some embodiments, when a user plays a virtual game on the client system 930, the game networking system 920b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular user and a particular virtual game. In some embodiments, while a user is not playing the virtual game, the corresponding BLOB may be stored in the database. This enables a user to stop playing the game at any time without losing the current state of the game the user is in. When a user resumes playing the game next time, game networking system 920b may retrieve the corresponding BLOB from the database to determine the most-recent values of the game-related data. In some embodiments, while a user is playing the virtual game, the game networking system 920b also loads the corresponding BLOB into a memory cache so that the game system may have faster access to the BLOB and the game-related data contained therein.

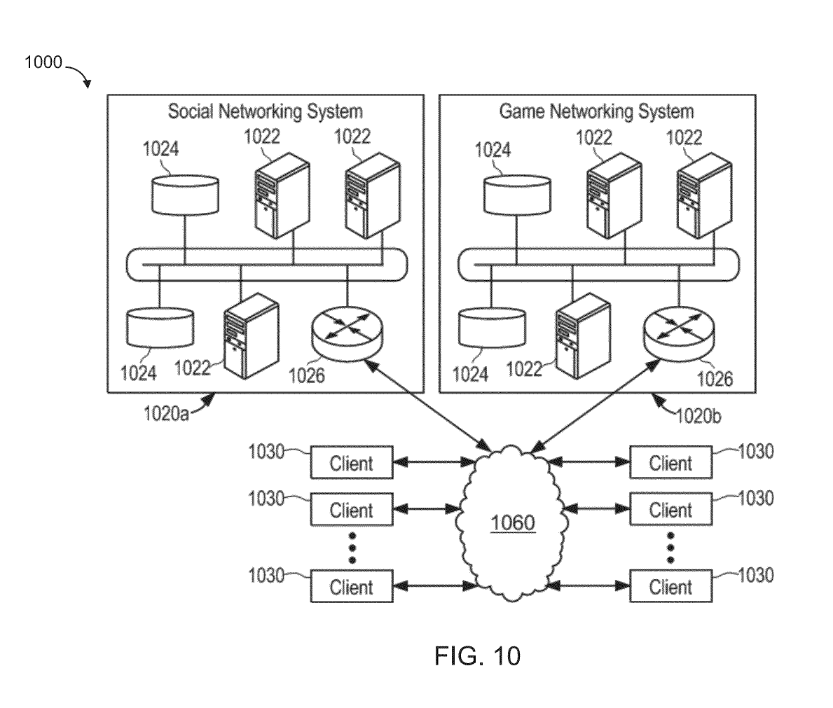

Various embodiments may operate in a WAN environment, such as the Internet, including multiple network addressable systems. FIG. 10 shows an example network environment 1000, in which various example embodiments may operate. A network cloud 1060 generally represents one or more interconnected networks, over which the systems and hosts described herein can communicate. Network cloud 1060 may include packet-based WANs (such as the Internet), private networks, wireless networks, satellite networks, cellular networks, paging networks, and the like. As FIG. 10 illustrates, various embodiments may operate in a network environment 1000 comprising one or more networking systems, such as a social networking system 1020a, a game networking system 1020b, and one or more client systems 1030. The components of the social networking system 1020a and the game networking system 1020b operate analogously; as such, hereinafter they may be referred to simply as the networking system 1020. The client systems 1030 are operably connected to the network cloud 1060 via a network service provider, a wireless carrier, or any other suitable means.

The networking system 1020 is a network addressable system that, in various example embodiments, comprises one or more physical servers 1022 and data stores 1024. The one or more physical servers 1022 are operably connected to computer network cloud 1060 via, by way of example, a set of routers and/or networking switches 1026. In an example embodiment, the functionality hosted by the one or more physical servers 1022 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), Flash, ActionScript, and the like.

The physical servers 1022 may host functionality directed to the operations of the networking system 1020. Hereinafter servers 1022 may be referred to as server 1022, although the server 1022 may include numerous servers hosting, for example, the networking system 1020, as well as other content distribution servers, data stores, and databases. Data store 1024 may store content and data relating to, and enabling operation of, the networking system 1020 as digital data objects. A data object, in some embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like.

Logically, data store 1024 corresponds to one or more of a variety of separate and integrated databases, such as relational databases and object-oriented databases, that maintain information as an integrated collection of logically related records or files stored on one or more physical systems. Structurally, data store 1024 may generally include one or more of a large class of data storage and management systems. In some embodiments, data store 1024 may be implemented by any suitable physical system(s) including components, such as one or more database servers, mass storage media, media library systems, storage area networks, data storage clouds, and the like. In one example embodiment, data store 1024 includes one or more servers, databases (e.g., MySQL), and/or data warehouses. Data store 1024 may include data associated with different networking system 1020 users and/or client systems 1030.

The client system 1030 is generally a computer or computing device including functionality for communicating (e.g., remotely) over a computer network. The client system 1030 may be a desktop computer, laptop computer, tablet computer, in- or out-of-car navigation system, smart phone or other cellular or mobile phone, or mobile gaming device, among other suitable computing devices. Client system 1030 may execute one or more client applications, such as a Web browser.

When a user at a client system 1030 desires to view a particular webpage (hereinafter also referred to as target structured document) hosted by the networking system 1020, the user's web browser, or other document rendering engine or suitable client application, formulates and transmits a request to the networking system 1020. The request generally includes a URL or other document identifier as well as metadata or other information. By way of example, the request may include information identifying the user, a timestamp identifying when the request was transmitted, and/or location information identifying a geographic location of the user's client system 1030 or a logical network location of the user's client system 1930.

Although the example network environment 1900 described above and illustrated in FIG. 10 is described with respect to the social networking system 1020a and the game networking system 1020b, this disclosure encompasses any suitable network environment using any suitable systems. For example, a network environment may include online media systems, online reviewing systems, online search engines, online advertising systems, or any combination of two or more such systems.

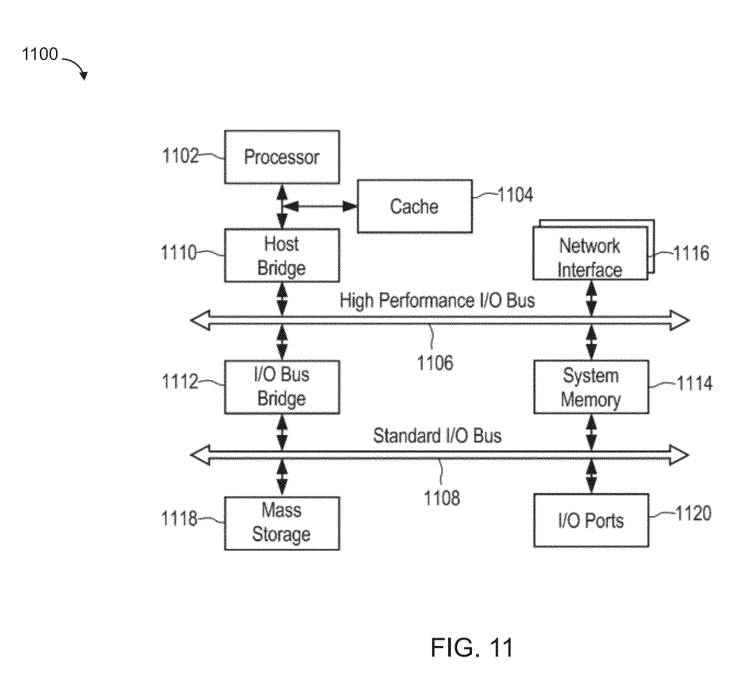

FIG. 11 illustrates an example computing system architecture, which may be used to implement a server 1022 or a client system 1030. In one embodiment, the hardware system 1100 comprises a processor 1102, a cache memory 1104, and one or more executable modules and drivers, stored on a tangible computer-readable storage medium, directed to the functions described herein. Additionally, the hardware system 1100 may include a high performance input/output (I/O) bus 1106 and a standard I/O bus 1108. A host bridge 1110 may couple the processor 1102 to the high performance I/O bus 1106, whereas the I/O bus bridge 1112 couples the two buses 1106 and 1108 to each other. A system memory 1114 and one or more network/communication interfaces 1116 may couple to the bus 1106. The hardware system 1100 may further include video memory (not shown) and a display device coupled to the video memory. Mass storage 1118 and I/O ports 1120 may couple to the bus 1108. The hardware system 1100 may optionally include a keyboard, a pointing device, and a display device (not shown) coupled to the bus 1108. Collectively, these elements are intended to represent a broad category of computer hardware systems.

The elements of the hardware system 1100 are described in greater detail below. In particular, the network interface 1116 provides communication between the hardware system 1100 and any of a wide range of networks, such as an Ethernet (e.g., IEEE 802.3) network, a backplane, or the like. The mass storage 1118 provides permanent storage for the data and programming instructions to perform the above-described functions implemented in servers 1022 of FIG. 10, whereas system memory 1114 (e.g., DRAM) provides temporary storage for the data and programming instructions when executed by the processor 1102. I/O ports 1120 are one or more serial and/or parallel communication ports that provide communication between additional peripheral devices, which may be coupled to the hardware system 1100.

The hardware system 1100 may include a variety of system architectures, and various components of the hardware system 1100 may be rearranged. For example, cache memory 1104 may be on-chip with the processor 1102. Alternatively, the cache memory 1104 and the processor 1102 may be packed together as a “processor module,” with processor 1102 being referred to as the “processor core.” Furthermore, certain embodiments of the present disclosure may neither require nor include all of the above components. For example, the peripheral devices shown coupled to the standard I/O bus 1108 may couple to the high performance I/O bus 1106. In addition, in some embodiments, only a single bus may exist, with the components of the hardware system 1100 being coupled to the single bus. Furthermore, the hardware system 1100 may include additional components, such as additional processors, storage devices, or memories.

An operating system manages and controls the operation of the hardware system 1100, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a,” “an,” or “the” is intended to mean “one or more” unless specifically indicated to the contrary. In addition, it is to be understood that functional operations, such as “awarding,” “locating,” “permitting,” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments, the term “web service” and “website” may be used interchangeably and, additionally, may refer to a custom or generalized API on a device, such as a mobile device (e.g., cellular phone, smart phone, personal GPS, personal digital assistance (PDA), personal gaming device, etc.), that makes API calls directly to a server. Still further, while the embodiments described above operate with business-related virtual objects (such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
capturing a photo of a game board within an online game;
modifying the captured photo based on input received from a user associated with the game board; and
sharing the modified photo with one or more players of the online game within a social network that includes the user.

2. The method of claim 1, further comprising:
receiving input from the one or more players of the online game; and
displaying the shared photo along with information associated with the received input.

3. The method of claim 1, further comprising:
receiving a comment from the one or more players of the online game; and
displaying the shared photo along with information associated with the received comment.

4. The method of claim 1, further comprising:
receiving input from the one or more players of the online game, the received input associated with a rating of the shared photo; and
displaying the shared photo along with the rating of the shared photo.

5. The method of claim 1, wherein capturing a photo of a game board includes capturing a section of a displayed game board.

6. The method of claim 1, wherein modifying the captured photo based on input received from a user associated with the game board includes applying a display filter to the captured photo to alter one or more display characteristics of the captured photo.

7. The method of claim 1, wherein modifying the captured photo based on input received from a user associated with the game board includes annotating the captured photo.

8. The method of claim 1, wherein sharing the modified photo with one or more players of the online game within a social network that includes the user includes sharing the photo with users of an in-game social network that includes the user.

9. The method of claim 1, wherein sharing the modified photo with one or more players of the online game within a social network that includes the user includes sharing the photo with users of an out-of-game social network that includes the user.

10. The method of claim 1, wherein sharing the modified photo with one or more players of the online game within a social network that includes the user includes sharing the photo with users currently playing an online game with the user.

11. The method of claim 1, wherein sharing the modified photo with one or more players of the online game within a social network that includes the user includes updating a photo album associated with the user to include the captured photo.

12. The method of claim 1, further comprising:
receiving an indication of an occurrence of a certain event within the online game; and
automatically capturing the photo of the game board within the online game in response to the occurrence of the event.

13. A system comprising:
a capture module that is configured to capture a photo of at least a portion of a player game board within an online game; and
an action module, wherein the action module is configured to perform an action associated with the captured photo.

14. The system of claim 13, further comprising:
a modify module, wherein the modify module is configured to modify a visual characteristic of the captured photo.

15. The system of claim 13, further comprising:
a tag module, wherein the tag module is configured to identify items displayed by the captured photo.

16. The system of claim 13, further comprising:
a feedback module, wherein the feedback module is configured to display an indication of feedback received from viewers of the captured photo along with the captured photo.

17. The system of claim 13, further comprising:
an album module, wherein the album module is configured to update an online album of photos with the captured photo.

18. The system of claim 13, further comprising:
an event module, wherein the event module is configured to identify an occurrence of an event within the online game environment and instruct the capture module to capture the photo in response to the occurrence of the event.

19. A computer-readable storage medium whose contents, when executed by a computing device, cause the computing device to perform operations, comprising:
identifying within a captured photo of a game board a virtual game item; and
displaying an indication to purchase the virtual game item along with the captured photo.

20. The computer-readable storage medium of claim 19, wherein displaying an indication to purchase the virtual game item along with the captured photo includes displaying a user-selectable graphical element that, when selected, initiates a purchase of the virtual game item for a viewer of the displayed photo that selects the displayed graphical element.
